(19) United States
(12) Patent Application Publication
(10) Pub. No.: US 2007/0067389 A1
(43) Pub. Date: Mar. 22, 2007

(54) PUBLISH/SUBSCRIBE MESSAGING SYSTEM

(75) Inventors: Bharat Veer Bedi, Hampshire (GB); Andrew James Stanford-Clark, Isle of Wight (GB)

Correspondence Address: IBM CORPORATION, 3039 CORNWALLIS RD., DEPT. T81 / B503, PO BOX 12195, REASEARCH TRIANGLE PARK, NC, 27709, US

(73) Assignee: International Business Machines Corporation, Armonk, CA (US)

(21) Appl. No.: 11/459,654

(22) Filed: Jul. 25, 2006

(30) Foreign Application Priority Data
Jul. 30, 2005 (GB) 0515713.6

(51) Int. Cl. G06F 15/16

(52) U.S. Cl. 709/204

(57) ABSTRACT

A method for managing subscription requests in a publish/subscribe messaging system. Clients register a subscription at a message broker via one protocol and receive messages in matching that subscription on another protocol.

### FIELD OF THE INVENTION

The invention relates generally to the field of message communication within data processing networks, and in particular to publish/subscribe (pub/sub) messaging over a network.

### BACKGROUND

Message deliver systems deliver messages through a network of servers (“brokers”) which provide routing and formatting services. Many message brokers support the publish/subscribe mode as a way of distributing messages. This involves a set of one or more publishers sending communications to a set of one or more subscribers who have registered their interest in receiving communications of a certain type. Subscribers notify the broker of the message types they wish to receive and this information is stored at the broker. Publishers send their messages to the broker which compares the message type (for example, checking message header topic fields or checking message content) with its stored subscriber information to determine which subscribers the message should be forwarded to. Publishers are generally not concerned with where the messages are being sent and subscribers are generally not interested in where the messages they receive have been sent from. The message broker may, also perfor additional functions, such as filtering, formatting or otherwise processing received messages before forwarding them to subscribers.

Publish/subscribe messaging allows subscribing users to receive the latest information on a topic of interest (for example, stock prices news flashes, special shopping offers or weather). In a typical publish/subscribe environment, a number of publisher applications send a number of messages to subscriber applications which may be located remotely across the network. The network over which computers communicate using such messaging include the Internet, an intranet or any computer network.

A message broker manages the distribution of messages according to valid subscriptions registered with the broker. Publishers and subscribers may also interact with a network of brokers, each one of which propagates subscriptions and forwards publications to other brokers within a network. Such networks typically include one or more message brokers located at a communications hub through which the publishers and subscribers communicate. The term “broker” used herein should be understood as encompassing a single broker or multiple brokers working together as a network to provide brokering services.

Message brokers typically communicate with each other and with subscribers using a single communication protocol or transport mechanism. Such protocol or transport mechanism will have an associated “quality of service” which determines the manner in which the brokers process the messages. Known quality of service characteristics include factors such as network bandwidth requirements, throughput, latency, error rate, compression, encryption, or the amount of memory or buffer space required for a data flow. The quality of service may not be appropriate for all messages or all subscribers. Use of an inappropriate protocol could result in many messages not being processed in the most efficient manner. Broker software may implement higher qualities of service that that provided by the communication protocol itself, but this results in complicated systems which are difficult to administer. It is also possible to use a communication protocol which supports the highest qualities of service, but this incurs overheads when processing messages which only require lower qualities of service and many messages are not handled in the most efficient manner.

Published U.S. patent application Ser. No. 2003/0115317A1 discloses a method of communication in a publish/subscribe environment for the economical delivery of messages primarily between brokers by determining the lowest quality of service which is sufficient for exchanging messages between them on a certain topic. This reduces the overhead associated with unnecessarily using a higher quality of service for inter-broker communication. It relies on brokers, at any time, being able to accept traffic on a set of different protocols which allows the transmitting broker to chose any protocol it deems appropriate based on the quality of service requirement. This method is concerned with inter-broker communications and does not address the problem of broker-subscriber communication.

Subscribers can connect and subscribe to a broker using a communication protocol that they also use for other transactions. However, a subscriber may desire such other transactions to take precedence over published messages, and the subscriber may be hindered by published messages congesting the network. There is a need for improved broker-subscriber communication.

U.S. Pat. No. 6,101,545 discloses a message handling system in which a sender can specify a message delivery type to designate whether a message is delivery-critical or time-critical. A message delivery selector then selects a protocol (for example, Transmission Control Protocol (TCP) or User Datagram Protocol (UDP)) based on the message delivery type. The sender of a message can specify a message delivery type which is analyzed and used to control selection of a message transport protocol, but no information about the intended recipient of the message is involved in this selection. In a message broker environment, an attempt to implement a solution based on U.S. Pat. No. 6,101,545 would result in many messages being processed inefficiently because a high quality of service specified by a sender will be honored even if not required by the recipient. In this system the intended recipient may be hindered by messages congesting the network.

There is need for a more efficient solution for message broker networks which addresses communication between brokers and subscribers.

### SUMMARY

Accordingly, the invention provides a method of communication in a publish/subscribe messaging system, the messaging system comprising a plurality of publishers publishing information to a broker and a plurality of subscribers subscribing to information received from one or more publishers via a broker, the method comprising the steps of: receiving a subscription request via a first communication protocol indicating topic information in which the requesting subscriber is interested; determining if the subscription request includes an indicator requesting published information to be sent via a second communication protocol; and responsive to the determining step, transmitting topic information via the second communications protocol if the subscription request does include the indicator, otherwise transmitting topic information via the first protocol.

According to another aspect, there is provided a message broker for managing communications in a publish/subscribe messaging system comprising a plurality of publishers publishing information to the broker and a plurality of subscribers subscribing to information received from one or more publishers via the broker, the broker comprising: means for receiving a subscription request via a first communication protocol indicating topic information in which the requesting subscriber is interested; means for determining if the subscription request includes an indicator requesting published information to be sent via a second communication protocol; and means, responsive to the determining means, for transmitting, topic information via the second communications protocol if the subscription request does include the indicator, otherwise transmitting topic information via the first protocol.

According to another aspect, the invention provides a computer program for managing communications in a publish/subscribe messaging system.

### BRIEF DESCRIPTION OF THE DRAWINGS

Preferred embodiments of the present invention will now be described, by way of example only, with reference to the following drawings in which:

FIG. 1 is a schematic representation of a messaging system in which publisher and subscriber applications communicate via a message broker;

FIG. 2 shows an example of a topic tree;

FIG. 3 is a flowchart illustrating the registration of a subscription profile in accordance with preferred embodiments; and

FIG. 4 illustrates the pertinent components of a message broker according to a preferred embodiment.

### DETAILED DESCRIPTION

IBM Corporation's WebSphere® MQ family of messaging products are examples of known products which support interoperation between application programs running on different systems in a distributed heterogeneous environment (WebSphere is a trademark of International Business Machines Corporation). The network via which the computers communicate using message queuing can be the Internet, an intranet or any other computer network. The WebSphere MQ products enable application programs to send messages to the input queue of other application programs, thereby achieving the delivery of messages between application programs which could be spread across a computer network, without requiring a dedicated end-to-end connection between the application programs. However the map of possible interconnections between the application programs can be quite complex.

Instead of having direct connections between the systems, the network architecture includes a communications hub to which other systems connect, thereby simplifying the complexity. Message brokering capabilities are provided at the communications hub to provide intelligent message routing and integration of applications. Message brokering functions include the ability to route messages intelligently according to rules and knowledge of the information requirements of different application programs using message “topic” information contained in message headers. Another message brokering function is the ability to transform message formats using the message format requirements of target applications or target systems to reconcile differences between systems and applications.

An example of a product that provides such message brokering capability by providing intelligent routing and transformation services for messages which are exchanged between application programs is IBM Corporation's WebSphere Business Integration Message Broker. Such message brokering capabilities could be integrated within other components of a data processing system, for example within the operating system software.

A multi-broker arrangement may be used to distribute load across processes, machines and geographical locations. When there is a large number of clients, it is beneficial to distribute those clients across several brokers to reduce resource requirements of the brokers and to reduce the impact should a particular server fail.

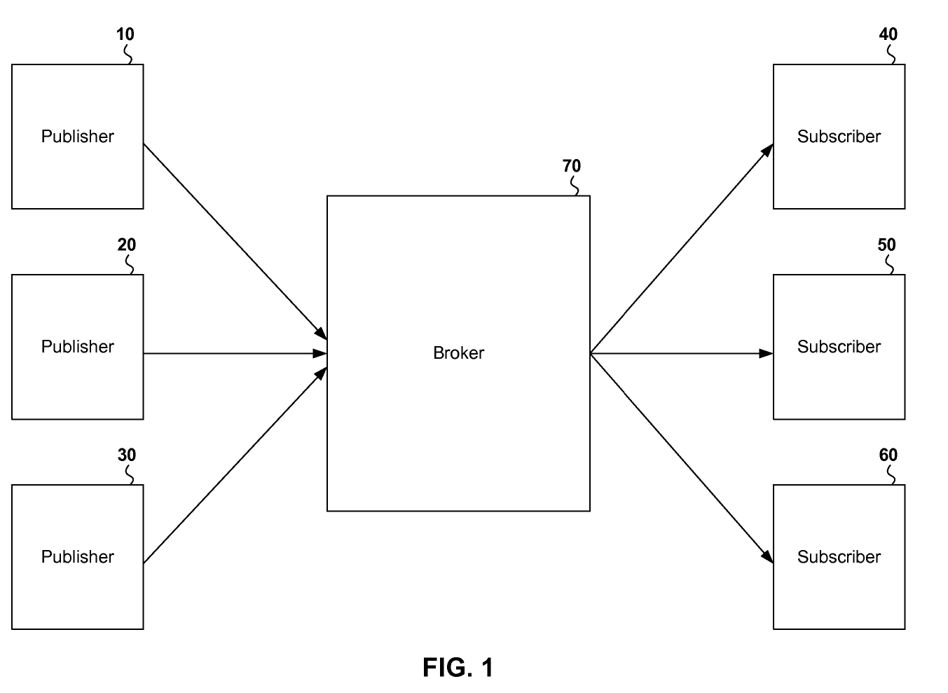

FIG. 1 shows an example of a network which one or more publisher applications 10, 20, 30 send messages to a message broker 70. The message broker may have one or more subscriber applications 40, 50, 60 that have registered their interest in receiving specified messages types from the publishers. In a typical publish/subscribe message broker environment, the publisher does not explicitly identify target subscribers, and may not know who the subscribers are. Publisher and subscriber applications do not have a dedicated end-to-end connection and at times may not be concurrently connected to the broker network. For example, a subscriber application may be located in a remote geographical location and connect to the broker via a communications satellite which is only available at certain times.

Publishers specify topic names for the messages they are publishing and subscribers specify topic names for the messages they are interested in receiving. The message broker 70 compares an incoming message with subscription profiles of the subscribers to identify matches and passes matching messages to an output component (not shown) for forwarding to the relevant subscribers. For example, subscriber 40 may be interested in the weather in London and may send a subscription request to the broker such as “weather/London”. The broker stores this subscription information against the appropriate topic in a topic tree and then if a message arrives at the broker from a publisher and the message header includes the topic identifier “weather/London” the broker compares this message with its subscription lists and identifies that the message matches the subscription profile for subscriber 40. The broker then routes the message to subscriber 40. Broker 70 may be a process, a set of processes or other executing, component or may be included within other application code. However, the logical function of the broker will exist somewhere in the network.

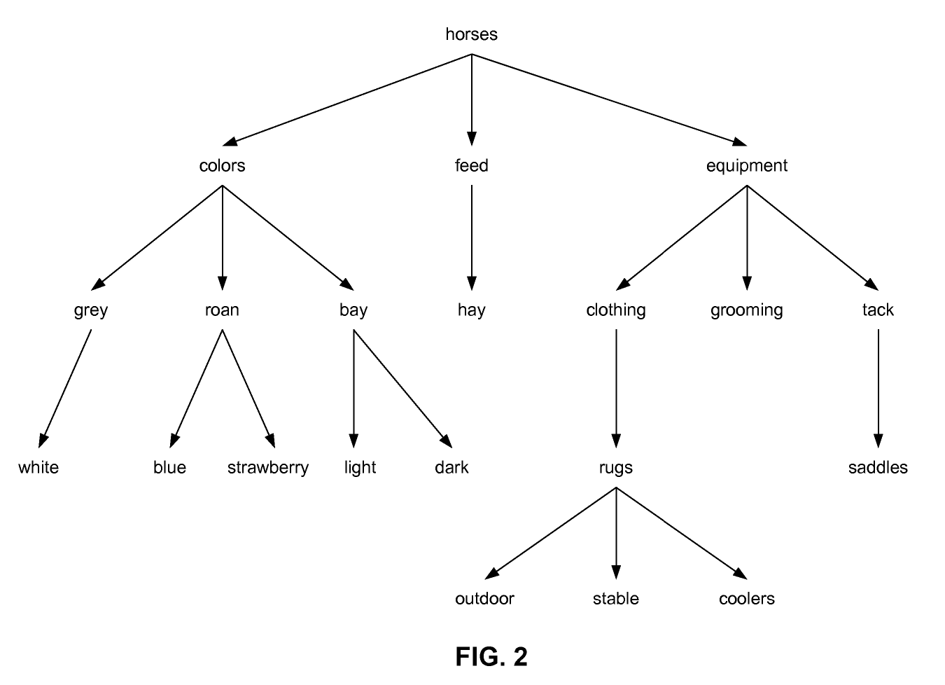

FIG. 2 shows an example topic tree. A topic tree is typically created based on a subscription request received at the broker. It can be seen in this example that “horses” is the main topic about which information is published. This topic can be divided into three categories: colors; feed; and equipment. Each category can then be subdivided e.g. colors—roan—strawberry. When a publication is received at the broker, it is parsed against the tree structure in order to match subscription requests already registered with the broker. For example, a subscriber may submit the following subscription to the broker: “horses/dark/bay/dark”.

Conventional message broker solutions use the same transport mechanism or protocol for all messages for transmitting publications to relevant subscribers. For example, a message broker within IBM's WebSphere Business Integration Message Broker product could be configured to always send messages with transactional assured delivery under the control of IBM's WebSphere message delivery software. In this example, the message transport mechanism is able to satisfy publisher-specified requirements for transactional message delivery. However, there are types of messages or subscribers for which transactional message delivery is unnecessary and for such cases a low-overhead delivery mechanism optimized for efficiency rather than delivery assurance may be employed e.g. share price updates.

The invention realizes that in some circumstances it might be desirable for subscribers to connect to the broker using one protocol and register a subscription, but have subsequent publications sent over a different protocol. This is enabled in accordance with a preferred embodiment by augmenting the subscription request to specify the protocol name and protocol specific identifier. For example, to receive SMS messages, the protocol name would be SMS and the ID would be a telephone number (i.e. a destination).

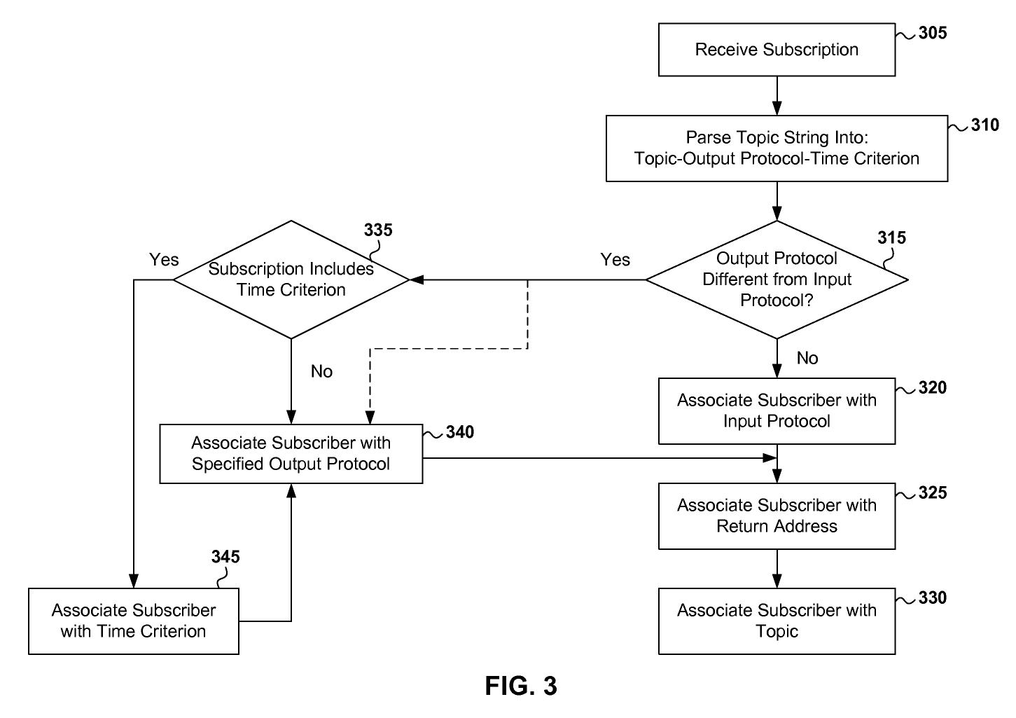

With reference to FIG. 3 a preferred method of registering a subscription profile with a broker will now be described. At step 305 the broker (see ref. 70 of FIG. 1) receives subscription requests. Subscription requests include an explicit topic hierarchy string (e.g. weather/hampshire/hursley). In accordance with one embodiment of the present invention, a subscription request includes two additional fields: one denoting the delivery protocol (if this is requested by the subscriber to be different from the requesting protocol) and the delivery address (if this is requested by the subscriber to be different to the requesting address). An example of such subscription request is “weather/hampshire/hursley”, “MQTelemetry”, “fred”. MQTelemetry is the delivery protocol requested by the subscriber and fred is the delivery address requested by the subscriber. The delivery address can be different from the requester's address.

At step 310 the broker parses the subscription request into the topic string, the output protocol and the output address.

A check is then made at step 315 to determine whether or not published messages are to be sent via the same protocol as the subscription was received. If a second protocol is not to be employed, then the subscriber is associated with the input protocol at step 320. The subscriber is then associated with the return address at step 325. The return address can be the same or different from the subscribing address and can be indicated in the subscription request. Then at step 330 the subscriber is associated with the topic. A subscriber listening in on the return address will receive the desired publications.

If published messages are to be sent via a different protocol then step 340 is carried out after step 315 as indicated by the dotted line. At step 340 the subscriber is associated with the specified output protocol before being associated with the return address at step 325.

In accordance with another embodiment of the present invention, a subscriber can specify that he or she wants publications to be sent during predetermined time frames. For example, a supermarket may be connected to a network using ISDN during normal business hours for online credit card validation, and uses a protocol that's suitable for use over that connection to subscribe to a broker for publications relating to barcode catalogue updates. However, the supermarket does not want to receive publications sent via the same protocol as that would congest the network and interfere with customer transactions. In accordance with this embodiment, the supermarket could subscribe to the broker using one protocol and receive publications via a second protocol over a satellite broadcast network during business hours or via the subscribing protocol when the supermarket is closed for business.

According to this embodiment of the invention, if it is determined at step 315 that the output protocol could be different from the subscribing protocol a check is then made at step 335 to determine whether or not the subscription request includes a time criterion. If the request does not specify a time criterion, then the subscriber is associated with the output protocol at step 340 and then with the return address at step 325.

However, if it is determined at step 335 that the subscription request does include a time criterion, then at step 345 the subscriber is associated in the broker with that time criterion and is then associated with the output protocol at step 340.

The time criterion can be requested by the subscriber such that publications are not sent to the return address between certain times such as, for example, during the opening hours of a supermarket. In this case the broker checks that the time criterion has been met before a publication is sent to the subscriber. The publication may be sent via the first or second protocol and will be held by the broker until the time criterion has been met.

According to yet another embodiment of the invention, the time criterion can be requested by the subscriber such that publications are sent to the return address via either the input protocol or the output protocol depending on when the publication is being sent. It will be appreciated that the present invention can be scaled such that publications may be sent via a larger number of protocols within different time frames and to any number of subscriber return addresses.

FIG. 5 shows components of a message broker in accordance with an embodiment of the present invention. The message broker 70 comprises a catching engine 100 which receives subscription requests (step 305) from subscribers via a first communications protocol. Known protocols suitable for use in the present invention include HTTP, WebSphere MQ, WebSphere MQ mobile, WebSphere MQ Telemetry Transport, and WebSphere MQ-Realtime. However, it is envisaged that the invention is capable of utilizing other communications protocols.

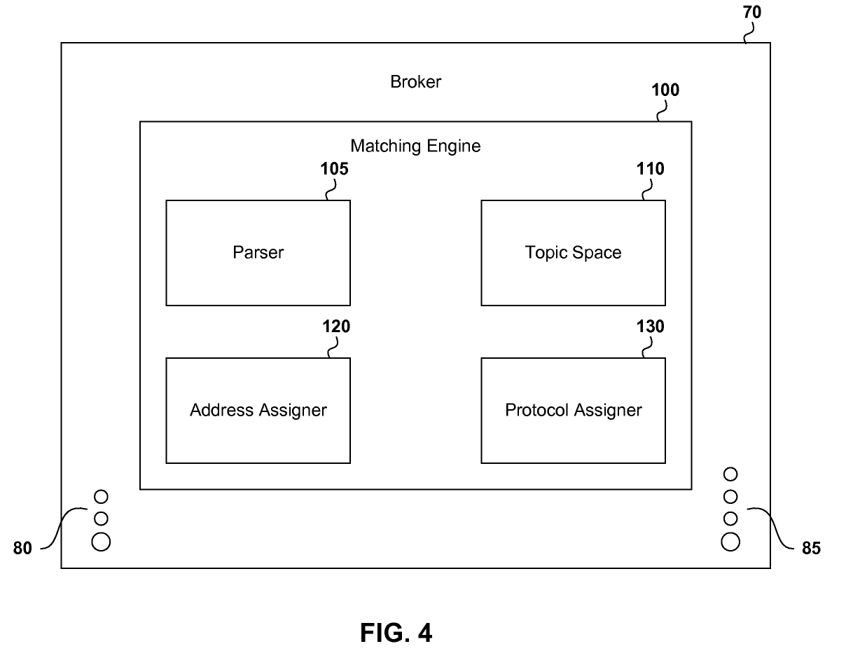

Subscription requests are received at the broker via input nodes 80 and registered with the broker. The matching engine uses parser component 105 to parse each subscription request into the topic string, output protocol and output address. The topic string is stored in topic space 110. Address assigner 120 assigns the output address (see step 325 of FIG. 3) and protocol assigner 130 assigns the output protocol or protocols (steps 320 and 340 of FIG. 4). The time assigner 140 is used when the subscription request includes a time criterion (as determined at step 335). Publications are sent to subscribers via the output nodes 85.

Published messages are sent from publishers (10, 20, 30) to a broker 70. When the message is received at the broker, it is parsed against the tree structure in topic space 110 in order to match subscription requests registered with the broker. The subscription requests may be stored with the tree structure in topic space 110 or can be stored in a separate look up table (not shown) accessible from the topic space. Subject to the conditions included in a subscription request (protocol, time, return address) publish messages are then sent from the broker to a subscriber.

We claim:

1. A method of communication in a publish/subscribe messaging system, the messaging system comprising a plurality of publishers publishing information to a broker and a plurality of subscribers subscribing to information received from one or more publishers via a broker, the method comprising the steps of:
receiving a subscription request via a first communication protocol indicating topic information in which the requesting subscriber is interested;
determining if said subscription request includes an indicator requesting published information to be sent via a second communication protocol; and
responsive to said determining step, transmitting topic information via said second communications protocol if said subscription request does include said indicator.

2. A method as claimed in claim 1, further comprising the step of transmitting topic information via said first communication protocol if said subscription request does not include said indicator.

3. A method as claimed in claim 1, wherein said subscription request further includes a time criterion associated with said second communication protocol and said determining step includes a step, responsive to a determination that said topic information is to be transmitted at a time within said time criterion, of transmitting said topic information via said second communication protocol if said time criterion is met.

4. A method as claimed in claim 3, further comprising the step of transmitting topic information via said first protocol if said time criterion is not met.

5. A method as claimed in claim 3, further comprising the step of delaying transmittal of a publication until a time occurring within said time criterion.

6. A method as claimed claim 1, further comprising the steps of:
determining if said subscription request specifies a delivery address; and
transmitting topic information to a delivery address if specified, otherwise, transmitting topic information to a requesting address.

7. A message broker for managing communications in a publish/subscribe messaging system comprising a plurality of publishers publishing information to the broker and a plurality of subscribers subscribing to information received from one or more publishers via said broker, the broker comprising:
means for receiving a subscription request via a first communication protocol indicating topic information in which the requesting subscriber is interested;
means for determining if said subscription request includes an indicator requesting published information to be sent via a second communication protocol; and
means, responsive to said determining means, for transmitting topic information via said second communications protocol if said subscription request does include said indicator.

8. A message broker as claimed in claim 7, further comprising means for transmitting topic information via said first communication protocol if said subscription request does not include said indicator.

9. A message broker as claimed in claim 7, wherein said determining means further includes means for determining if said subscription request has a time criterion associated with said second communication protocol.

10. A message broker as claimed in claim 9, further comprising means for delaying transmittal of a publication until a time occurring within said time criterion.

11. A message broker as claimed in claim 7, further comprising:
means for determining if said subscription request specifies a delivery address; and
means for transmitting topic information to a delivery address if specified, otherwise, transmitting topic information to a requesting address

12. A computer program product for communication in a publish/subscribe messaging system, the messaging system comprising a plurality of publishers publishing information to a broker and a plurality of subscribers subscribing to information received from one or more publishers via a broker, the computer program product comprising a computer readable medium having computer readable program code tangibly embedded therein, the computer readable program code comprising:
computer readable program code configured to receive a subscription request via a first communication protocol indicating topic information in which the requesting subscriber is interested;
computer readable program code configured to determine if said subscription request includes an indicator requesting published information to be sent via a second communication protocol; and
computer readable program code configured to, responsive to a determination, transmit topic information via said second communications protocol if said subscription request does include said indicator.

13. A computer program product as claimed in claim 12, further comprising, computer readable program code configured to transmit topic information via said first communication protocol if said subscription request does not include said indicator.

14. A computer program product as claimed in claim 12, wherein said subscription request further includes a time criterion associated with said second communication protocol and said computer readable program code configured to determine includes computer readable program code configured to transmit, responsive to a determination that said topic information is to be transmitted at a time within said time criterion, said topic information via said second communication protocol if said time criterion is met.

15. A computer program product as claimed in claim 14, further comprising computer readable program code configured to transmit topic information via said first protocol if said time criterion is not met.

16. A computer program product as claimed in claim 14, further comprising computer readable program code configured to delay transmittal of a publication until a time occurring within said time criterion.

17. A computer program product as claimed claim 12, further comprising:
computer readable program code configured to determine if said subscription request specifies a delivery address; and
computer readable program code configured to transmit topic information to a delivery address if specified, otherwise, to transmit topic information to a requesting address.
